(19) United States
(12) Patent Application Publication
(10) Pub. No.: US 2012/0184167 A1
(43) Pub. Date: Jul. 19, 2012

(54) COMPOSITE MATERIAL

(75) Inventors: Keith Watkinson, Cheshire (GB); Marc Stang, Manchester (GB); Charles Fitzhugh, Cheshire (GB); Gordon Ewan, Wemyss Bay (GB)

(73) Assignee: BENTLEY MOTORS LIMITED, Cheshire (GB)

(21) Appl. No.: 13/319,172

(22) PCT Filed: May 14, 2010
(86) PCT No.: PCT/GB2010/050788

§ 371 Date: Jan. 23, 2012

(30) Foreign Application Priority Data
May 14, 2009 (GB) 0908257.9

(51) Int. Cl. B32B 5/02; B32B 9/02; B32B 38/00; B32B 37/12; B32B 37/06; D03D 15/00; B32B 27/12

(52) U.S. Cl. 442/189; 428/221; 442/181; 428/332; 428/340; 428/337; 156/60; 156/280; 156/306.6

(57) ABSTRACT

A composite material formed from a sheet of material (1) consisting essentially of animal hide bonded to a textile material (3). The sheet of material may be leather and the textile material a woven, coated textile. The two materials may be bonded together with a hot melt adhesive which may be provided as a film or web (2). Bonding the sheet material to a textile material increases the dimensional stability of the material when exposed to sunlight and heat, making it suitable for use in the manufacture of sun blinds for vehicles, such as automobiles.

The present invention relates to a composite material, a blind formed from the composite material and a method of manufacture of the composite material.

Leather is widely used as a trim material, particularly for the interiors of quality vehicles, especially automobiles. Vehicles, particularly automobiles, tend to have a large glass area. In addition to a windscreen and a rear and side windows it is known to equip automobiles with a wholly or partially glazed roof. Consequently, blinds may be fitted to screen vehicle windows and glazed roofs to provide passenger privacy and shield passengers from the sunlight.

For aesthetic reasons it is desirable for the interior of any blinds to match or compliment the interior of a vehicle. To this end it is desired to use leather as a material to form blinds, for example roller blinds. However, there are significant practical drawbacks in using leather in this way as leather is dimensionally unstable when exposed to changes in temperature and humidity and subjected to sunlight. In fact, the applicant has found that natural leather suffers from dimensional changes of about 5% when exposed to heat equivalent to that experienced by an automotive window or roof blind during normal use. This degree of instability is unacceptable. Embodiments of the present invention seek to address this problem.

According to a first aspect of the present invention there is provided a composite material comprising a sheet of material consisting essentially of animal hide bonded to a textile material.

According to a second aspect of the present invention there is provided a method of manufacture of a composite material comprising the steps of:

providing a sheet material consisting essentially of animal hide;

providing a textile material; and

bonding the sheet and textile materials together to form a composite material.

It is found that by bonding a textile material to the hide material its dimensional stability is improved, making embodiments of the invention suitable for use in window and roof blind applications.

The sheet material is preferably leather. Leather is to be understood to be an appropriately treated animal hide. Whilst a bonded or processed “leather” material could be used its use is not preferred for aesthetic and quality reasons. The leather is preferably skived. The leather preferably has a thickness in the range 0.5 to 0.7 mm.

The leather is preferably shrink optimised in order to minimise subsequent shrinkage and dimensional instability.

The textile is preferably woven. It is preferably woven from a polyester yarn. The yarn preferably has a mass in the range 150 to 180 Dtex. The textile is preferably coated and may be coated with a water based polyurethane coating. The coating may be applied at a rate in the range 125-145 g/m². The textile may have an overall mass in the range 150-170 g/m². The textile may have a thickness in the range 0.1-0.3 mm and preferably in the range 0.18-0.24 mm The textile preferably has a tensile strength of at least 250 N, more preferably at least 300 N. For a woven textile this relates to strength in both warp and weft directions.

The textile is preferably substantially light fast.

The textile and sheet material are preferably bonded together by way of an adhesive. The adhesive is preferably a hot melt adhesive. The adhesive is preferably provided in the form of one or more lay ups of film or web. The film or web preferably has a mass in the range of 28-90 g/m² . Two or more lay ups of film may be employed to provide a sufficient mass of adhesive.

The adhesive preferably has a minimum activation temperature of 130° C. and a maximum activation temperature of 180° C.

The adhesive film or films is/are preferably sandwiched between the sheet material and textile to form a lay up, and the lay up placed into a heated static press. The materials are preferably subjected to a pressure of at least 4 N/cm² in the press. The materials preferably remain under pressure within the press for 10 to 30 seconds. At least one side of the press is preferably heated to a temperature in the range 170° C. to 190° C. and the other side of the press to a temperature in the range 50° C.-70° C.

On removal from the press the bonded material is preferably trimmed to size with a knife. The composite material may be used to form a blind, such as a roller blind.

In order that the invention may be more clearly understood an embodiment thereof is now be described, by way of example, with reference to the accompanying drawings of which:

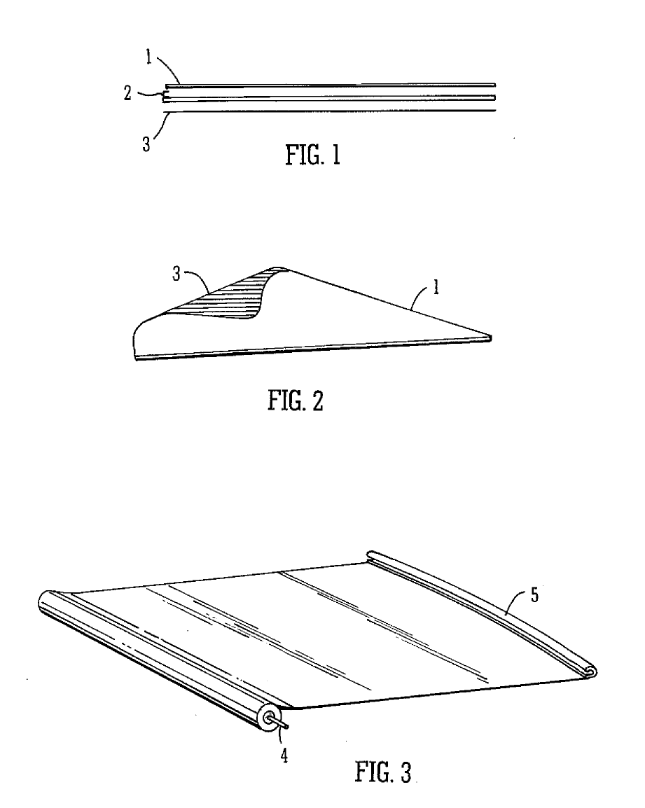

FIG. 1 is a side view of a lay up of materials for forming a composite material according to the invention;

FIG. 2 is perspective view of the materials of FIG. 1 after bonding; and

FIG. 3 is a roller blind formed from the composite material of FIG. 2.

Referring to the drawings, a composite material is formed by assembling a lay up comprising:
(i) a pre-shrunk sheet of skived leather 1 of approximate thickness 0.7 mm with its grain side directed to the outside of the lay up;
(ii) two layers of a transparent copolyamide adhesive film 2, each of approximate thickness 15-25 μm, such as that sold by Protechnic of 66 rue des Fabrique, 6870 Cernay, Cedex, France under the name TEXIRON 199; and
(iii) a UV stable woven polyester textile 3 woven with black warp and weft yarns of approximately 167 Dtex coated with a grey water based polyurethane coating at the rate of about 35 g/m² to give an overall textile mass of approximately 164 g/m^{2.}

In an alternative embodiment the two layers of adhesive film described at (ii) above are replaced with a single layer of a transparent copolyamide adhesive film of approximate thickness 80 um. Suitable adhesive film is available from Tag Composites and Carpets GmbH, Krefeld, Germany.

The layers are superimposed with the adhesive film layers 2 between the leather 1 and the textile 3 and the assembled lay ups placed between the heated plates of a press. The lay up is arranged so that the leather lies against a plate heated to about 60° C. and the textile 3 lies against a plate heated to about 180° C. The plates are then brought together under a pressure of 4.5 N/cm² for a period of from 10 to 30 seconds. This causes the adhesive 2 to melt and flow onto the surface of the leather and into the textile 3 bonding them together to form a composite material shown in FIG. 2.

The composite material is then trimmed to size with a knife.

The trimmed material is then attached to a roller blind shaft 4 at one end and to an elongate support 5 at the other end for fitment to a window or roof of an automobile, or other vehicle or application, with the leather 1 facing the inside of the vehicle and the textile 3 facing the glazing.

It is found that bonding the leather to the chosen fabric significantly improves the dimensional stability of the leather, as compared to leather on its own when exposed to sunlight, changes of temperature and humidity. Whereas leather on its own may suffer shrinkage of up to 5%, composites according to the invention suffer negligible shrinkage.

The above embodiment is described by way of example only. Many variations are possible without departing from the invention as defined by the appended claims.

1. A sunblind comprising a sheet of material consisting essentially of animal hide bonded to a textile material.

2. A sunblind as claimed in claim 1, wherein the sheet material is leather.

3. A sunblind as claimed in claim 2, wherein the leather is skived.

4. A sunblind as claimed in claim 2, wherein the leather has a thickness in the range 0.5 to 0.7 mm.

5. A sunblind as claimed in claim 1, wherein the textile material is woven.

6. A sunblind as claimed in claim 5, wherein the textile material is woven from a polyester yarn.

7. A sunblind as claimed in claim 6, wherein the yarn has a mass in the range 150 to 180 Dtex.

8. A sunblind as claimed in claim 1, wherein the textile material is coated.

9. A sunblind as claimed in claim 8, wherein the textile material is coated with a water based polyurethane coating.

10. A sunblind as claimed in claim 1, wherein the textile material has a mass in the range 150 to 170 g/m².

11. A sunblind as claimed in claim 1, wherein the textile material has a thickness in the range 0.1 to 0.3 mm.

12. A sunblind as claimed in claim 1, wherein the textile material has a tensile strength of at least 250 N.

13. A sunblind as claimed in claim 1, wherein the textile material is substantially light fast.

14. A sunblind as claimed in claim 1, wherein the textile and sheet materials are bonded together by way of an adhesive.

15. A sunblind as claimed in claim 1 wherein the material comprises a composite material.

16. A method of manufacture of a sunblind comprising the steps of: providing a sheet material consisting essentially of animal hide; providing a textile material and bonding the sheet and textile materials together to form a composite material.

17. A method as claimed in claim 16 further comprising the step of applying a coating to the textile material.

18. A method as claimed in claim 17, wherein the coating is applied at a rate in the range 150 to 170 g/m².

19. A method as claimed in claim 16 wherein the sheet and textile materials are bonded together with a hot melt adhesive.

20. A method as claimed in claim 19, wherein the adhesive is provided in the form of a film or web.

21. A method as claimed in claim 20, wherein the film or web has a mass in the range 28 to 90 g/m².

22. A method as claimed in claim 20, wherein the adhesive film or web is sandwiched between the sheet material and textile to form a lay up, and the lay up placed into a heated press.

23. A method as claimed in claim 22, wherein the materials are subjected to a pressure of at least 4 N/cm² in the press for 10 to 30 seconds.

24. A method as claimed in claim 22, wherein at least one side of the press is heated to a temperature in the range 170° C. to 190° C. and another side of the press to a temperature in the range 50° C. to 70° C.
